(19) United States
(12) Patent Application Publication
(10) Pub. No.: US 2021/0078736 A1
(43) Pub. Date: Mar. 18, 2021

(54) SPACE TRANSPORT SYSTEM

(71) Applicant: The Aerospace Corporation, El Segundo, CA (US)

(72) Inventors: Blake A. ROGERS, Hermosa Beach, CA (US); Randy M. VILLAHERMOSA, La Canada Flintridge, CA (US); Joshua P. DAVIS, Redondo Beach, CA (US); Lael F. WOODS, Merritt Island, FL (US); Barik SMITH, Leesburg, VA (US)

(73) Assignee: The Aerospace Corporation

(21) Appl. No.: 17/014,230

(22) Filed: Sep. 8, 2020

Related U.S. Application Data
(60) Provisional application No. 62/899,221, filed on Sep. 12, 2019.

(51) Int. Cl. B64G 1/64; B64G 1/00; B64G 1/54

(52) U.S. Cl. CPC B64G 1/646; B64G 1/422; B64G 1/543; B64G 1/007

(57) ABSTRACT

A space transport system includes one or more cyclers orbiting between a first planetary body and another planetary body. The space transport system also includes one or more taxi vehicles, each of which carry cargo, humans, or both. The one or more taxi vehicles dock with the one or more cyclers and undock with the one or more cyclers when landing on the first planetary body or the second planetary body.

### CROSS-REFERENCE TO RELATED APPLICATIONS

This application claims the benefit of U.S. Provisional Application No. 62/899,221, filed on Sep. 12, 2019. The subject matter thereof is hereby incorporated herein by reference in its entirety.

### FIELD

The present invention relates to space transport, and more particularly, to transporting or delivering mass from Earth to space and beyond.

### BACKGROUND

When the United States sent men to the Moon in the 1960s and 1970s, the architecture consisted of the following steps. First, the launch vehicle (Saturn V) and upper stage launched the Command and Service Module (CSM) and the Lunar Module (LM) onto a trajectory to arrive at the Moon. Three (3) days later, they arrive at the far side of the Moon and a lunar orbit insertion maneuver is performed to put the CSM and LM into orbit around the Moon. The LM is then undocked from the CSM and landed on the surface of the Moon. A day later, the LM ascends from the surface of the Moon and docks with the CSM. The astronauts all move aboard the CSM, and the LM is jettisoned to be discarded. The CSM then performs a maneuver to return to the Earth. At Earth, the Command Module, containing the astronauts, separates from the Service Module, and the Command Module then reenters the atmosphere.

Architectures to transport humans and cargo to the Moon that are currently being considered are slightly more complex, but not all that different from the Apollo era architecture. For example, the Artemis architecture (missions being prepared to go to the Moon in 2024 timeframe) is as follows:
A small station is built to orbit the Moon (Lunar Gateway).
A lunar lander is sent to the Lunar Gateway.
A large launch vehicle (SLS) launches a spacecraft (Orion) onto a trajectory to arrive at the Moon.
The Orion arrives at the Moon and performs a maneuver to rendezvous with the Lunar Gateway. The crew transfers into the gateway and then into the lander.
The crew takes the lander to the surface of the Moon. After some time on the surface of the Moon, the crew takes the lander from the surface of the Moon back to Lunar Gateway.
The crew transfers to Gateway and then back to Orion. Orion disembarks from Lunar Gateway and performs a maneuver to return from Earth.

These Apollo and Artemis architectures are appropriate for sending a handful of missions to the Moon. Apollo performed 6 manned landings on the Moon, and the Artemis project's current plans for approximately the same number of landings on the Moon. The end goal of Artemis (and other proposed lunar missions), however, is to establish a permanent human presence on the Moon. After this presence is established, there needs to be a system to regularly and efficiently transport humans from the surface of the Earth to the surface of the Moon and back. Thus, a space transport system is needed.

### SUMMARY

Certain embodiments of the present invention may provide solutions to the problems and needs in the art that have not yet been fully identified, appreciated, or solved by current space transport technologies. Some embodiments generally pertain to a space transport system configured to deliver mass, such as cargo, payload, satellites, and/or passengers, from Earth to space and beyond. For example, the space transport system may deliver humans, cargo, and/or satellites from the surface of the Earth to LEO, GEO, Lunar Orbit, and/or the Lunar surface with the option and/or capability to return humans, cargo, and/or satellites to the surface of the Earth.

In an embodiment, a space transport system includes one or more cyclers orbiting between a first planetary body and another planetary body. The space transport system also includes one or more taxi vehicles, each of which carry cargo, humans, or both. The one or more taxi vehicles dock with the one or more cyclers and undock with the one or more cyclers when landing on the first planetary body or the second planetary body.

In another embodiment, a process for transporting or delivering cargo, humans, or both between a first planetary body and a second planetary body includes launching one or more cyclers from Earth and into space. The process also includes configuring the one or more cyclers to enter a cycling trajectory between Earth or a first planetary body and a second planetary body, and docking a taxi vehicle with the one or more cyclers to transport the taxi vehicle from Earth or the first planetary body and to the second planetary body.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is a diagram illustrating a rendezvous procedure between a cycler and a taxi vehicle, according to an embodiment of the present invention.

FIG. 2 is a diagram illustrating a cycler delivering system for delivering cargo to lunar surface, according to an embodiment of the present invention.

FIG. 3 is a diagram illustrating a geostationary orbit (GEO) insertion procedure, according to an embodiment of the present invention.

FIG. 4 is a diagram illustrating a string of pearls transport system, according to an embodiment of the present invention.

FIG. 5 is a diagram illustrating a relay system for pushing cycler from one planetary body to another, according to an embodiment of the present invention.

FIG. 6 is a diagram illustrating a process for launching a cycler from Earth to space, according to an embodiment of the present invention.

FIG. 7 is a diagram illustrating a process for rendezvousing a taxi vehicle with the cycler, according to an embodiment of the present invention.

FIG. 8 is a diagram illustrating a process for landing on a surface of a planetary body, according to an embodiment of the present invention.

FIGS. 9A-D are diagrams illustrating a cycler, according to an embodiment of the present invention.

FIG. 10 is a diagram illustrating a taxi vehicle docked with the cycler vehicle, according to an embodiment of the present invention.

FIGS. 11 and 12 are diagrams illustrating a space transport system, according to an embodiment of the present invention.

FIG. 13 is a diagram illustrating an attitude determination and control system when a taxi rendezvous and dock with a cycler, according to an embodiment of the present invention.

FIG. 14 is a diagram illustrating a cycler, according to an embodiment of the present invention.

### DETAILED DESCRIPTION OF THE EMBODIMENTS

Some embodiments generally pertain to a space transport system that uses one or more cycler vehicles (hereinafter “cyclers”) on a cycling trajectory to repeatedly deliver and return humans and cargo to and from a lunar planet. The cyclers are designed to safely transport humans, clean air, and water, and provide ample radiation protection to the cargo, humans, or both. The cyclers may autonomously perform any and all propulsive maneuvers required for station keeping purposes.

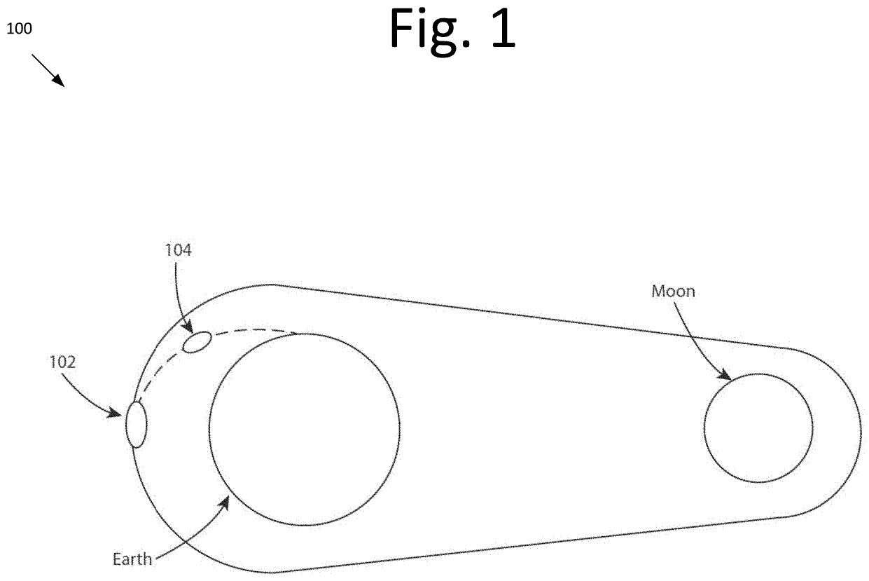

FIG. 1 is a diagram illustrating a rendezvous procedure 100 between a cycler 102 and a taxi vehicle 104, according to an embodiment of the present invention. In this embodiment, rendezvous between taxi vehicle 104 and cycler 102 may occur when cycler 102 is orbiting the Earth or Moon, for example.

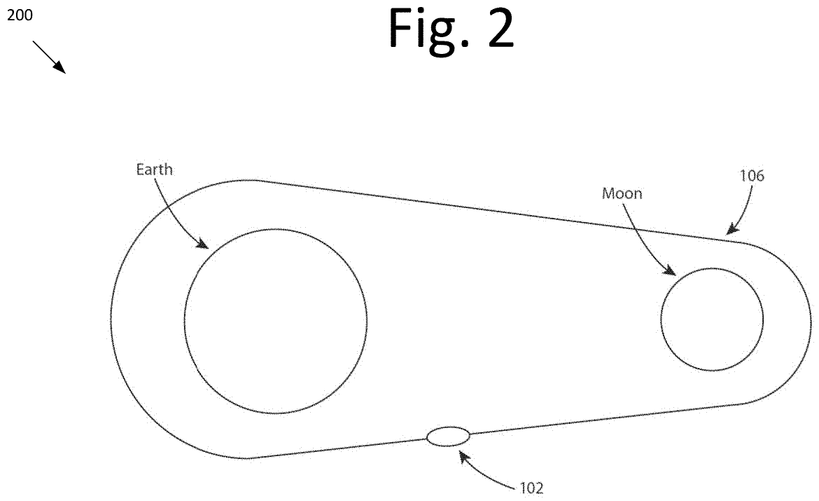

FIG. 2 is a diagram illustrating a cycler delivering system 200 for delivering humans, cargo, etc. to lunar surface, according to an embodiment of the present invention. In this embodiment, cycler 102 is on a cycling trajectory 106 between the Earth and Moon. There are a few possible options for inserting the cycler 102 onto the cycling trajectory. For example, a series of chemical propulsive maneuvers are performed to achieve the required velocity, thereby pointing cycler 102 at the Moon. In another example, electric propulsion (such as solar electric propulsion or nuclear electric propulsion) is performed to slowly increase the energy and shape the orbit into a desired trajectory. In yet another example, either chemical or electric propulsion are performed, but in an orbit with less energy, to push cycler 102 onto an orbit that passes close to the Moon. Finally, a gravity assist procedure may be performed by cycler 102 around the Moon to increase the energy of the orbit and to target the velocity vectors that are needed.

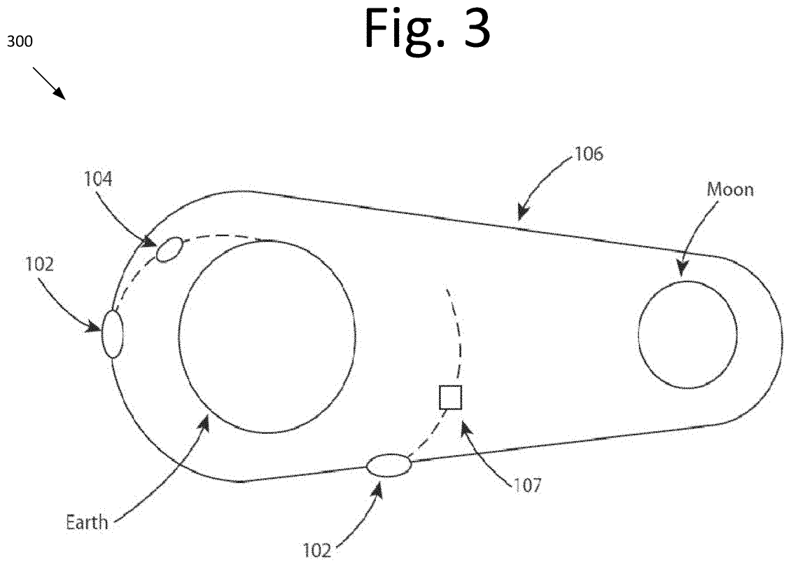

FIG. 3 is a diagram illustrating a GEO insertion procedure 300, according to an embodiment of the present invention. In one example, cycler 102 may deliver spacecrafts 107 into their orbits. If there is excess capability on a taxi vehicle 104 for a given mission, another space vehicle could ride taxi vehicle 104 to cycler 102, rendezvous with cycler 102, be taken to another location along the cycler 102 trajectory (or orbit) 106, and then be dropped off.

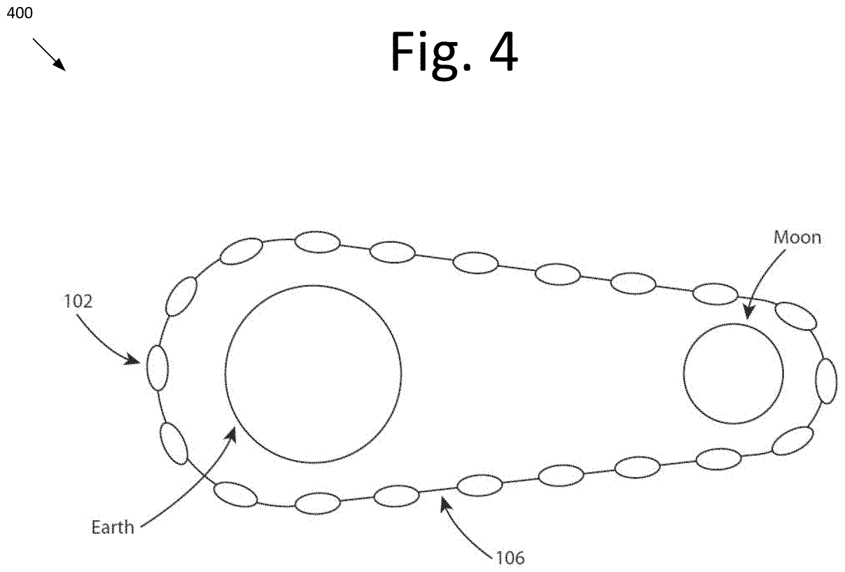

FIG. 4 is a diagram illustrating a string of pearls transport system 400, according to an embodiment of the present invention. In this embodiment, multiple cyclers 102 are on cycling trajectory 106, just at different times, between Earth and the Moon. It should be appreciated that cycling trajectories may be from the Moon to Mars, for example, or between other planetary bodies. Returning to this embodiment, with cycling trajectory 106, this may be similar to a city bus schedule that has multiple buses along the same route but separated in time by a regular interval. By having multiple cyclers 102 on the same cycling trajectory 106, although at different times, delivery of cargo or humans on taxi vehicles may be achieved in a more efficient manner. Note, in some embodiments, that each of cycler 102 on the string of pearls carries a taxi vehicle that the occupants use to travel to and from the surface of the Earth and Moon.

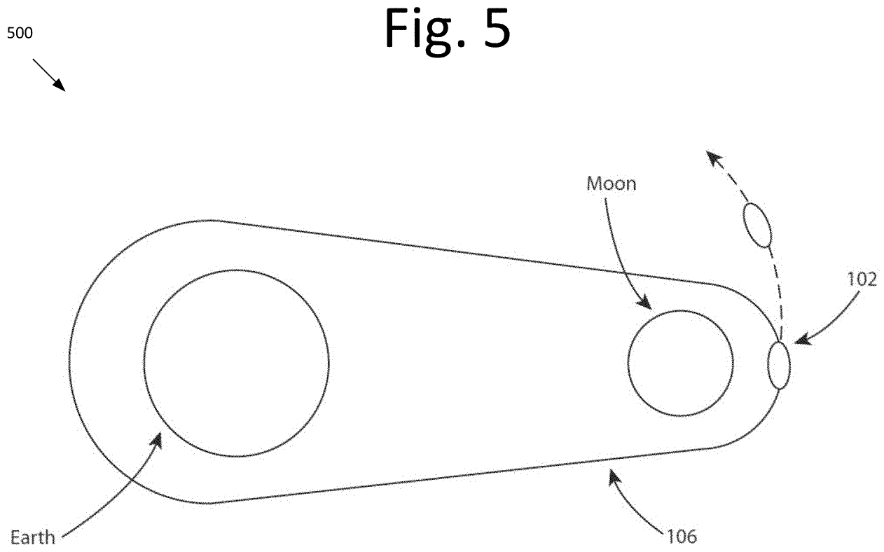

FIG. 5 is a diagram illustrating a relay system 500 for pushing cycler 102 from one planetary body to another, according to an embodiment of the present invention. In an embodiment, once cycler 102 is on its lunar cycling trajectory 106, if at some point, cycler 102 is to move to another plant such as Mars, a flyby of the Moon may be targeted. This flyby may impart energy to help cycler 102 escape the Earth's gravity and transition to an orbit around the Sun. It should be appreciated that more energy may be used to get the cycler 102 onto the proper cycling orbit of the destined plant. For this reason, engines on cycler 102 may be used to impart that energy. Using Mars as an example, cycler 102 will not orbit Mars, instead cycler 102 may be on an Earth-Mars cycling trajectory (similar to the Earth-Moon cycling trajectory). An Earth-Mars cycling trajectory is an orbit around the Sun that encounters the Earth and Mars regularly. The Earth-Mars orbit may vary, but in general it takes about 6 months to get from the Earth to Mars and the period of the orbit is 2 1/7 years. This may vary as technology for cycler 102 improves.

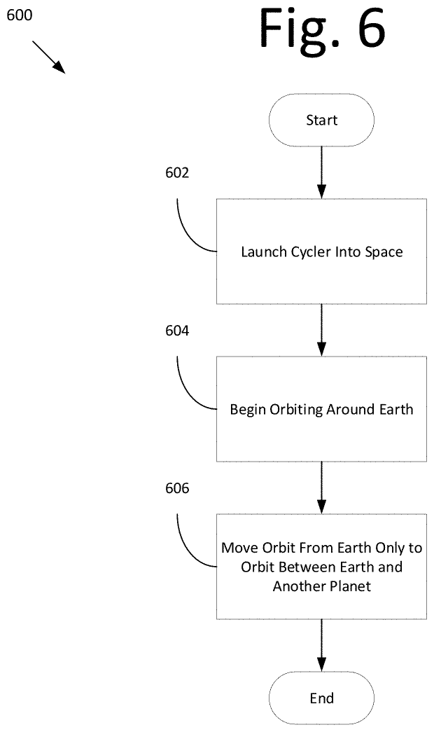

FIG. 6 is diagram illustrating a process 600 for launching a cycler from Earth to space, according to an embodiment of the present invention. In this embodiment, process 600 begins with launching the cycler from Earth and into space at 602. Once in space, the cycler begins to orbit around the Earth at 604, and at 606, the cycler begins to orbit between and around the Earth and Moon, for example. Cycler trajectories under consideration include (but are not exclusively) orbits that are resonant with the Moon in the Earth-Moon circular restricted three-body problem. These orbits are noted as m:n, where the cycler completes m orbits when the Moon completes n orbits. The orbits exist for any whole numbers m and n, but some are more advantageous than others.

In some embodiments, the cycler may contain mass required of a transport, but only needs to be launched once. That is, the cycler is reusable for multiple missions to and from the Moon. Further, multiple cyclers may be launched in space and designed to follow the similar orbit as the other cyclers. This may allow for frequent transport of smaller taxi vehicles. The smaller taxi vehicles may carry crew or cargo to and from the cycler. These taxi vehicles are smaller in size than spacecraft usually required to deliver humans and cargo from the Earth to the Moon, thus reducing the amount of propellant.

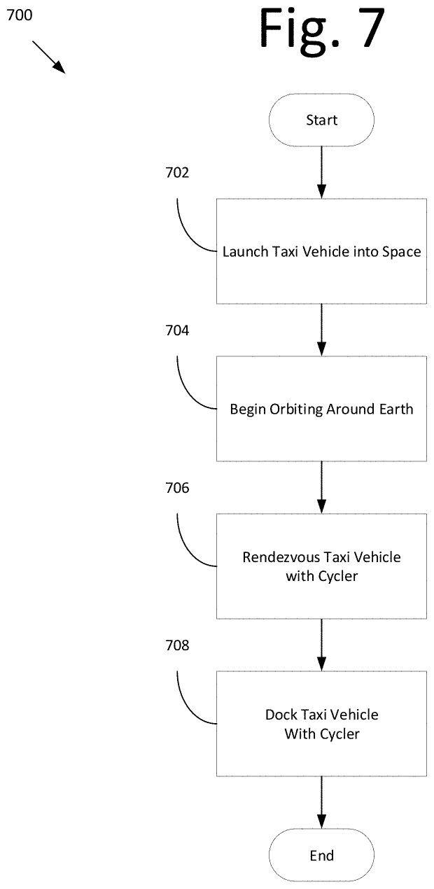

FIG. 7 is a diagram illustrating a process 700 for docking a taxi vehicle with the cycler, according to an embodiment of the present invention. In this embodiment, process 700 may begin at 702 with launching the taxi vehicle from Earth and into space (e.g. into LEO, GEO, or beyond). Once the taxi vehicle is in space, the taxi vehicle at 704 enters an orbit around the Earth. At 706, the taxi vehicle approaches the cycler and rendezvous with the cycler. At 708, the taxi vehicle docks with the cycler. By docking the ‘taxi’ vehicle with the cycler, the taxi vehicle is transported to the destination, e.g., the Moon. A similar process may be undertaken to launch multiple taxi vehicles in space for the purpose of docking with the cyclers, which may be orbiting between the Earth and the Moon or any planetary body.

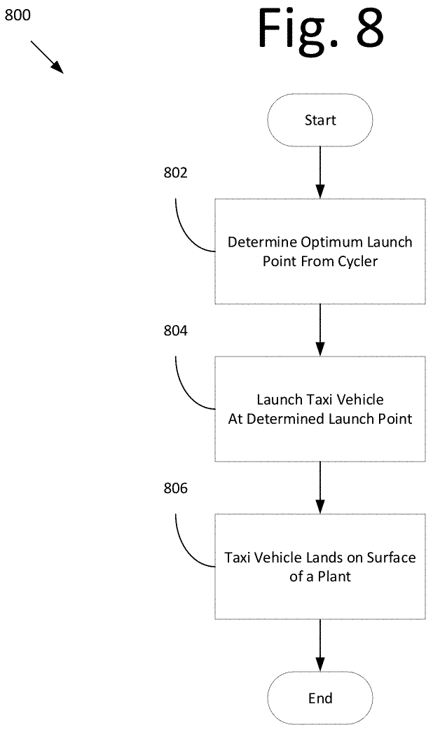

The launch of multiple taxi vehicles and cyclers may be referred to as string of pearls. For example, the string of pearls concept means that there are multiple cyclers on the cycling trajectory, just at different times. This way, the cyclers can transport multiple taxi vehicles. FIG. 8 is a diagram illustrating a process 800 for landing on a surface of a lunar planet, according to an embodiment of the present invention. In the embodiment, process 800 may begin at 802 with determining the optimum launch point for the taxi vehicle' when the cycler is near the lunar planet. At 804, the taxi vehicle is launched from the cycler, when the cycler is near the lunar planet. For example, when the cycler is orbiting around the Moon, the taxi vehicle containing the cargo or humans may be launched from the cycler. The taxi vehicle may have sufficient power to launch from the Moon at a later date/time. At 806, the taxi vehicle lands on the surface of a planetary body.

Relay to Mars

Once the cycler vehicle is on its lunar cycling trajectory, if it is desirable to send it to Mars, a flyby of the Moon can be targeted that will impart energy to help the vehicle escape the Earth's gravity and transition to an orbit around the Sun. It will take more energy to get the vehicle onto the proper Mars cycling orbit, so the vehicles engines will be used to impart that energy. It will not be orbiting Mars, instead it will be on an Earth-Mars cycling trajectory (similar to the Earth-Moon cycling trajectory it was originally used for). An Earth-Mars cycling trajectory is an orbit around the Sun that encounters the Earth and Mars regularly. The Earth-Mars orbit can vary, but in general it will take about 6 months to get from the Earth to Mars and the period of the orbit is 2 1/7 years.

Cycler

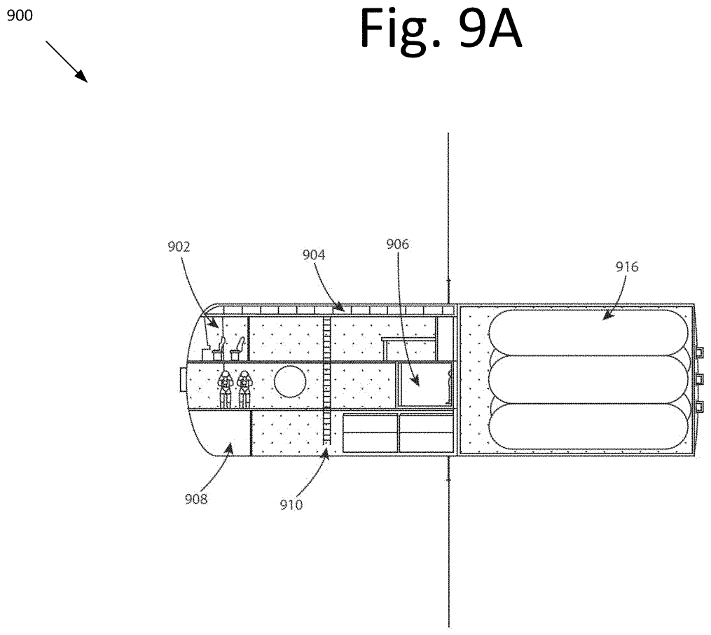

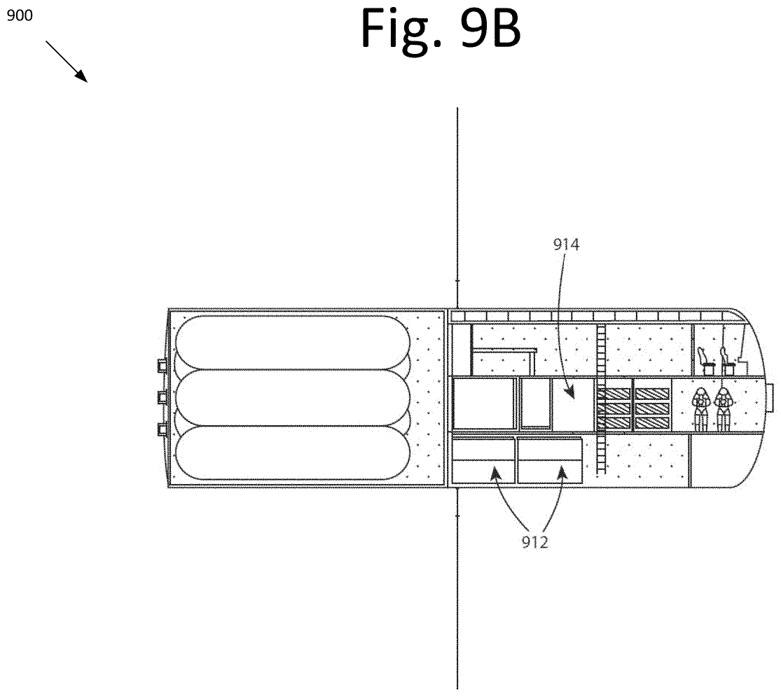

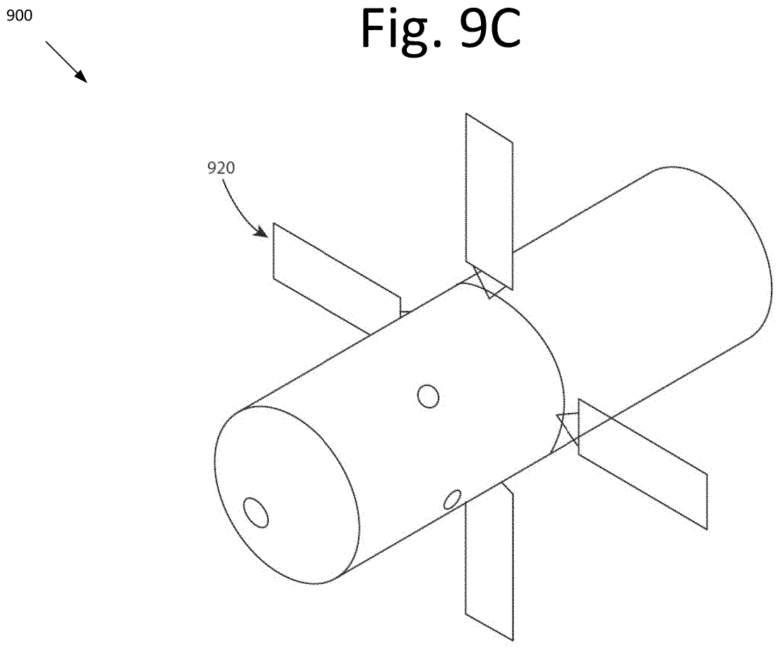

FIGS. 9A-D are diagrams illustrating a cycler 900, according to an embodiment of the present invention. In an embodiment, when a taxi vehicle is docked with cycler 900, passengers may move freely from taxi vehicle and into cycler 900. Cycler 900 in some embodiments is large enough for passengers to move freely within.

In some embodiments, cycler 900 includes a flight control compartment 902, a storage compartment 904, and a cabin 906 for passengers. Cycler may also include a hull 908. Although this embodiment illustrates a flight control compartment 902 for human pilots; other embodiments may be fitted with autopilot controls. Storage compartment 904 may be used for holding science experiments, extra equipment, consumables for the crew, items to be discarded, or any other item that does not have a permanent place onboard. Cabin 906 may include one or more sleeping cabins for the passenger(s).

In certain embodiments, a radiation shield 910 surrounds cycler 900 to protect passengers and/or cargo from radiation (e.g., Van Allen radiation belts). Radiation shield 910 is a passive shield in so far that it includes a mass between the radiation sources and the crew. Radiational shield 910 may be composed of water, e.g., one or more separated layers of drinking water and water that has yet to be recycled. In another embodiment radiation shield 910 may be composed of one or more separated layers of metals such as aluminum, copper, tantalum, etc. Radiation shield 910 is sufficient to reduce the radiation that a person would otherwise be exposed to from the Van Allen radiation belts to acceptable levels. In some additional embodiments, cycler 900 may include a smaller, more heavily shielded area in or near cabin 906 for higher level radiation events such as a solar flare.

Near the front end of cycler 900 are additional storage compartments 912 and a waste and hygiene compartment 914. Additional storage compartments 912 may serve a similar purpose as storage compartment 904.

Near the rear of cycler 900 are a plurality of propellant tanks 916. Thrusters 918 protruding from rear of cycler 900 may provide directional thrust.

Solar arrays 920 are also included on cycler 900. These solar arrays 920 may provide power to run the spacecraft subsystems, such as life support and propulsion. In other embodiments, a nuclear reactor may be used to provide power. In some embodiments, cycler 900 may include four solar arrays sized for a 20 percent end-of-life (EOL) power margin.

Taxi Vehicle

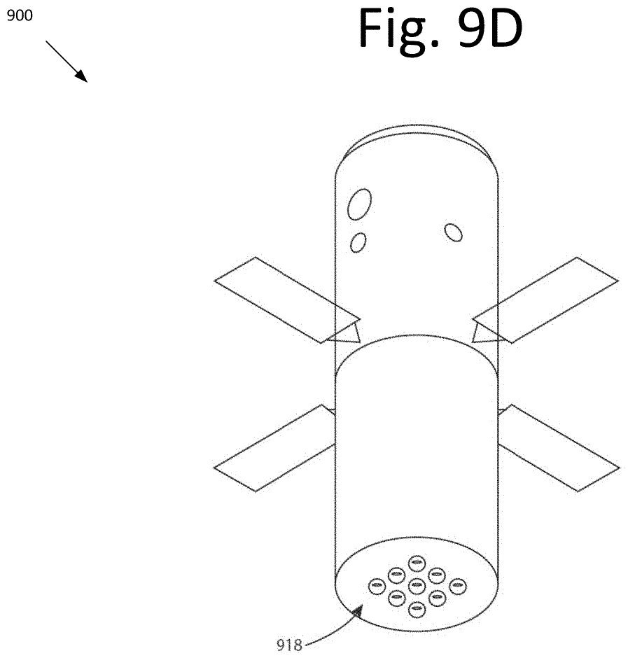

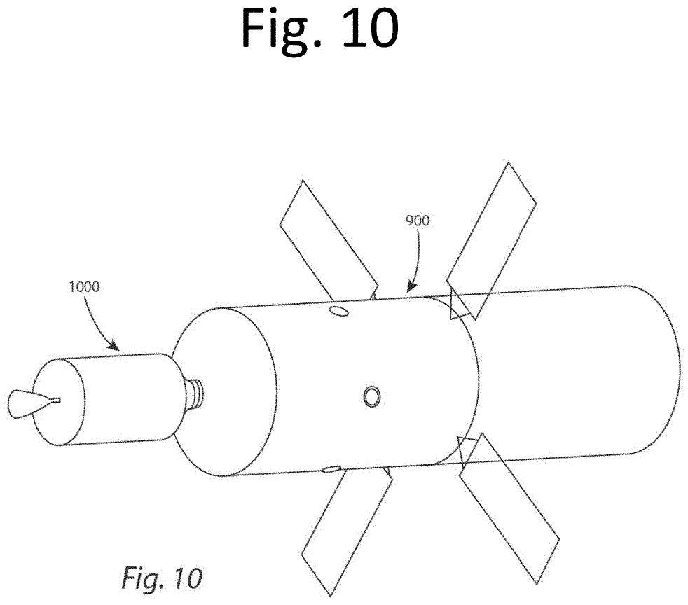

FIG. 10 is a diagram illustrating a taxi vehicle 1000, according to an embodiment of the present invention. In an embodiment, taxi vehicle 1000 may dock nose first into the front end of cycler 900. By docking nose first, rendezvousing of taxi vehicle 1000 is simpler and easier, since the docking is on the same axis as the main thruster allowing for finer control.

In certain embodiments, taxi vehicle 1000 can be used as extra space during the journey between the Earth and the Moon. Further, taxi vehicle 1000 is reusable for many missions between the cycler and the surface of a planetary body. Embodiments may require propellants to be supplied at regular intervals.

Taxi vehicle 100 may rendezvous with the cycler directly from the Earth after being launched on a launch vehicle. In another embodiment, taxi vehicle 1000 may ferry crew between space stations in orbit of the Earth or Moon to the cycler vehicle.

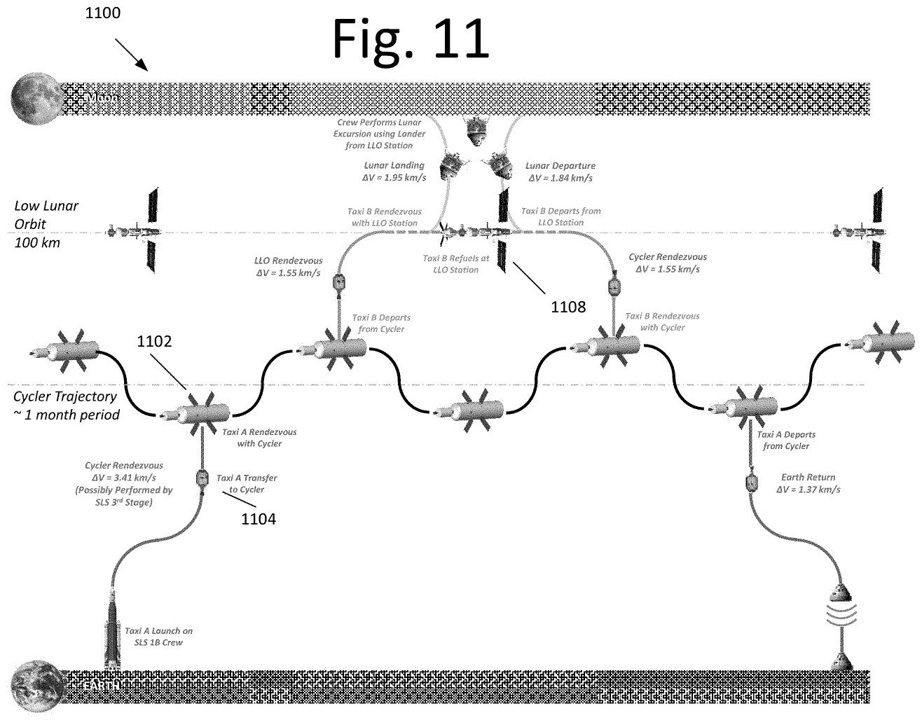

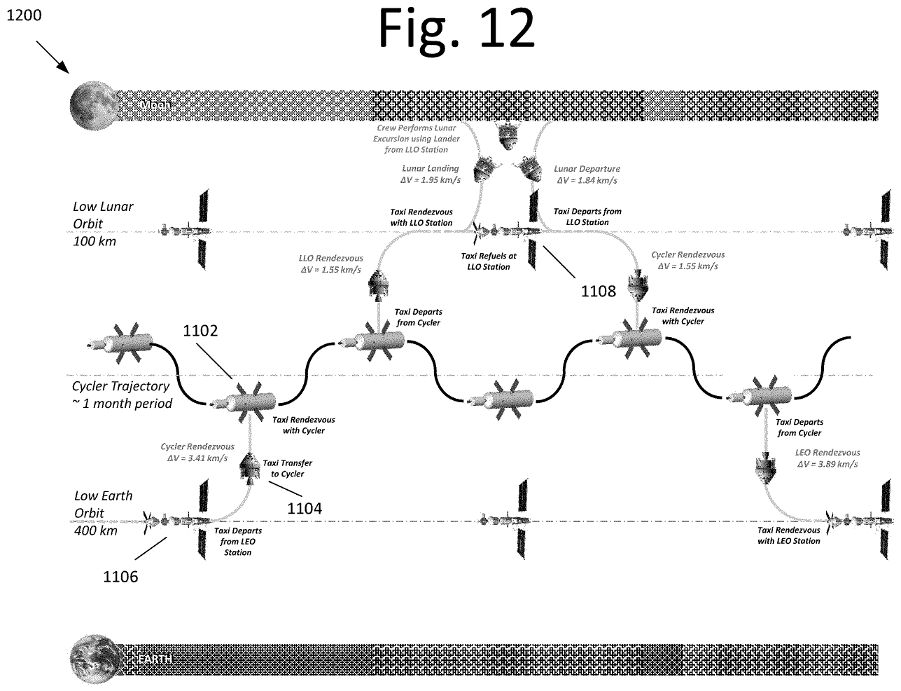

FIGS. 11 and 12 are diagrams illustrating a space transport system 1100 and 1200, according to an embodiment of the present invention. As shown in FIGS. 11 and 12, space transport system includes a cycler 1102 that orbits between a planet (e.g., Earth) and a lunar planet (e.g., the Moon). Space transport system also includes a taxi 1104, each of which carry humans, cargo, or both.

In FIG. 11, taxi 1104 may be launched from Earth on a Space Launch System (SLS) rocket, for example. Taxi 1104 may orbit around the Earth, and when cycler 1102 is near or proximate to taxi 1104, then taxi 1104 may rendezvous with cycler 1102. In another embodiment, such as that shown in FIG. 12, taxi 1104 may dock with an Earth orbiting (EO) station 1106, and when cycler 1102 is near or proximate to taxi 1104, then taxi 1104 may undock from the EO station 1106 and later rendezvous with cycler 1102 when cycler 1102 is proximate to taxi 1104. In this embodiment, EO altitude may be approximately 400 km; however, this may depend on various factors, primarily the size of the planet and the orbit of the cycler.

Depending on the embodiment, when taxi 1104 rendezvous with cycler 1102, the change in velocity (ΔV) required to be performed by taxi 1104 to rendezvous with the cycler 1102 may be 3.41 km/s. This change is velocity is dependent on several factors, including the initial and final orbit altitudes of taxi 1104 and the velocity of cycler 1102. The maneuvers undertaken by taxi 1104 include, but are not limited to, raising the altitude of its orbit to correspond to the same orbit altitude of the cycler 1102 and to match the velocity and position of the cycler 1102. Once the velocity and position of cycler 1102 and taxi 1104 are the same, the two spacecraft will physically attach via a mechanical interface.

Depending on the embodiment, when cycler 1102 is proximate to another low orbit station 1108 or another planetary object, taxi 1104 may undock from cycler 1102 and dock with another low orbit station 1108 or begin decent into the atmosphere of the other planetary object. In this embodiment, the lunar orbit (LO) altitude of station 1108 may be 100 km. Again, this altitude may depend on the size of the planet and orbit of the cycler.

The rendezvous of taxi 1104 and station 1108 may require taxi 1104 to perform a ΔV of 1.55 km/s. When taxi 1104 docks with station 1108, taxi 1104 may refuel, allowing taxi 1104 to have sufficient amount of fuel to land on the surface of the other planet and return to station 1108. The lunar landing speed of taxi may require a ΔV at 1.95 km/s.

Sometime later, when cycler 1102 has completed a number of orbits around the Earth and returns to the Moon, taxi 1104 may depart from the surface of the Moon to begin the return to Earth in the reverse order of events required to deliver it to the surface of the Moon. for example, taxi 1104 docks with station 1108 and then refuels. Taxi 1104 may then depart from station 1108 to rendezvous and dock with cycler 1102. When cycler 1102 and taxi 1104 return to the vicinity of the Earth, taxi 1104 undocks from cycler 1102 and perform a ΔV to return to the surface of the Earth.

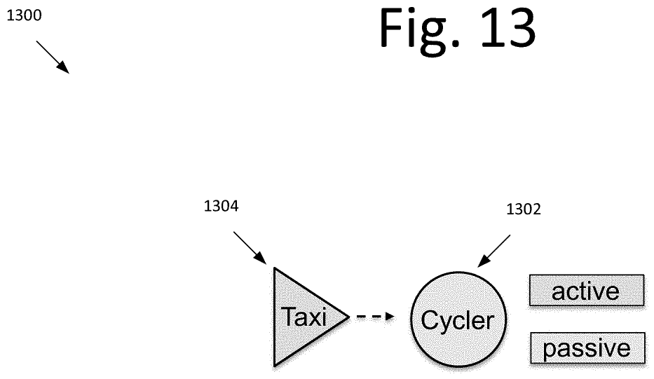

FIG. 13 is a diagram illustrating an attitude determination and control system when a taxi 1304 rendezvous and dock with a cycler 1302, according to an embodiment of the present invention. In some embodiments, taxi 1304 is in an active mode and cycler 1302 is in the passive mode. Cycler 1302 is in passive mode due to its larger mass, meaning that it would require more force to make the fine adjustments to its orbit required for docking with the taxi. As such, cycler 1302 may not adjust its orbit parameters during the docking phase (i.e., cycler 1302 is passive). On the other hand, taxi 1304 may be required to make all the adjustments to exactly match cycler's 1302 position and velocity so that docking can be accomplished safely at low relative velocities (i.e., taxi 1304 is active). Because taxi 1304 is the active element of the rendezvous and docking, taxi 1304 may require additional sensors to establish accurate positional data of both itself and cycler 1302. These sensors may include, but are not limited to, ranging devices (e.g., LIDAR), cameras in all light spectrums (infrared, visible, ultraviolet, etc.), inertial measurement units, Earth and star sensors, magnetometers, GPS receivers/transmitters, etc. The attitude of cycler 1302 may be stabilized by either spinning the spacecraft (spin stabilization) or by using a combination of thrusters and reaction wheels to keep the spacecraft in a desired orientation (3-axis stabilization). Taxi 1304 may be required to match the orientation of cycler 1302 at the time of docking.

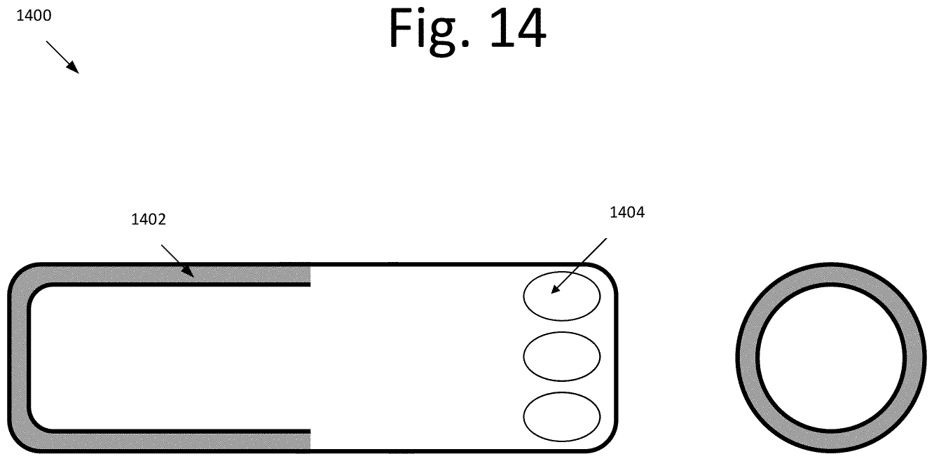

FIG. 14 is a diagram illustrating a cycler 1400, according to an embodiment of the present invention. In some embodiment, cycler 1400 includes a radiation shield 1402 that contains water. In this example, half of cycler 1400 is surrounded by water of some thickness. The thickness may be determined based on engineering requirements.

The rear of cycler 1400 comprises propellant tank(s) 1404. In an embodiment, electric propulsion is used with a propellant such as xenon. The advantages of electric propulsion are its efficiency (requiring less propellant mass than other propulsion methods for some orbits) and the ease of propellant storage. In another embodiment, a chemical rocket engine is used with a combination of liquid hydrogen and liquid oxygen as propellant. The advantage of this chemical engine is that very high values of thrust can be imparted upon the spacecraft.

Some embodiments generally pertain to one or more cyclers orbiting between a first planetary body and second planetary body. In some further embodiments, one or more taxi vehicles carrying cargo, humans, or both, dock with the one or more cyclers and undock with the one or more cyclers when landing on the first planetary body or the second planetary body.

It will be readily understood that the components of various embodiments of the present invention, as generally described and illustrated in the figures herein, may be arranged and designed in a wide variety of different configurations. Thus, the detailed description of the embodiments, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A space transport system, comprising:
one or more cyclers continuously orbiting between a first planetary body and a second planetary body; and
one or more taxi vehicles each of which carry cargo, humans, or both, wherein
the one or more taxi vehicles are configured to
rendezvous and dock with the one or more cyclers when the one or more cyclers are in close proximity, and
rendezvous and undock with the one or more cyclers when the one or more cyclers are close to a low orbit spacecraft or when landing on the first planetary body or the second planetary body.

2. The space transport system of claim 1, wherein the one or more cyclers comprise a radiation shield configured to protect the cargo, humans, or both.

3. The space transport system of claim 2, wherein the radiation shield is comprised of a mass between a radiation source and the humans.

4. The space transport system of claim 2, wherein the radiation shield comprises of one or more separated layers of drinking water and water yet to be recycled.

5. The space transport system of claim 2, wherein the radiation shield comprises of one or more layers metals.

6. The space transport system of claim 1, wherein the cycler comprises one or more solar arrays powering subsystems of the cycler, nuclear reactor powering subsystems of the cycler, or electrochemical powering subsystems of the cycler.

7. The space transport system of claim 1, wherein the one or more taxi vehicles is configured to dock nose first into a front end of the cycler.

8. The space transport system of claim 1, wherein the one or more taxi vehicles are configured to continuously orbit around the first planetary body or the second planetary body prior to docking with the low orbit spacecraft or the one or more cyclers.

9. A process for transporting or delivering cargo, humans, or both between a first planetary body and a second planetary body, the process comprising:
launching one or more cyclers from Earth and into space;
configuring the one or more cyclers to enter a cycling trajectory between Earth or a first planetary body and a second planetary body; and
docking a taxi vehicle with the one or more cyclers to transport the taxi vehicle from Earth or the first planetary body and to the second planetary body.

10. The process of claim 8, wherein the configuring of the one or more cyclers comprises inserting the cycler onto the cycling trajectory by performing a series of chemical propulsive maneuvers to point the cycler to the second planetary body or by performing electric propulsion to gradually increase energy and shape of orbit into a desired direction, or both.

11. The process of claim 8, further comprising:
rendezvousing a space vehicle attached to the taxi vehicle with the cycler; and
undocking the space vehicle from cycler at a predefined location in the cycling trajectory.

12. The process of claim 11, wherein the one or more cyclers placed on the cycling trajectory form a string of pearls to deliver cargo, humans, or both, from Earth or the first planetary body to the second planetary body and visa-versa.

13. The process of claim 11, wherein each of the one or more cyclers forming the string of pearls carry a taxi vehicle.

14. A space transport system, comprising:
a plurality of cyclers on a cycling trajectory between a first planetary body and a second planetary body, wherein
each of the plurality of cyclers on the cycling trajectory form a string of pearls carrying a taxi vehicle,
the taxi vehicle carries cargo, human, or both, from the first planetary body to the second planetary body and visa-versa.

15. The space transport system of claim 14, wherein the each of the plurality of cyclers are configured to perform a flyby of a second planetary body to escape gravity of the first planetary body and transition to an orbit around the sun.

16. The space transport system of claim 14, wherein the taxi vehicle is configured to rendezvous with one of the plurality of cyclers when the one of the plurality of cyclers is orbiting around the first planetary body or the second planetary body.

17. The space transport system of claim 14, wherein each of the plurality of cyclers are configured to perform a series of chemical propulsive maneuvers to achieve required velocity, thereby pointing the cycler at the first planetary body or the second planetary body.

18. The space transport system of claim 14, wherein each of the plurality of cyclers are configured to perform electric propulsion to slowly increase energy and shape orbit of the cycler into a desired trajectory.

19. The space transport system of claim 14, when one of the plurality of cyclers is in an orbit with less energy, the one of the plurality of cyclers is configured to perform chemical propulsion, electric propulsion, or both, to push the one of the plurality of cyclers onto an orbit that passes close to the first planetary body or the second planetary body.

20. The space transport system of claim 14, wherein each of the plurality of cyclers are configured to perform one or more gravity assist procedures around the first planetary body or the second planetary body to increase energy of the orbit and to target required velocity vectors.

21. The space transport system of claim 14, wherein each of the plurality of cyclers comprises a radiation shield to protect passengers, cargo, or both, from radiation.

22. The space transport system of claim 22, wherein the radiation shield comprises a mass between a radiation source and the passengers, cargo, or both, the mass being composed of water, one or more layers of metal, or both.
